(19) United States
(12) Patent Application Publication
(10) Pub. No.: US 2021/0171325 A1
(43) Pub. Date: Jun. 10, 2021

(54) HYDRAULIC CONTROL SYSTEM FOR ON-VEHICLE WINCH

(71) Applicants: Devan Anthony Soetemans, London (CA); Quinn Mathew Schmidt, Bay City, MI (US)

(72) Inventors: Devan Anthony Soetemans, London (CA); Quinn Mathew Schmidt, Bay City, MI (US)

(21) Appl. No.: 17/112,822

(22) Filed: Dec. 4, 2020

Related U.S. Application Data
(60) Provisional application No. 62/944,962, filed on Dec. 6, 2019.

(51) Int. Cl. B66D 1/44; F15B 15/08; F15B 9/14

(52) U.S. Cl. CPC B66D 1/44; F15B 9/14; F15B 15/08

(57) ABSTRACT

A hydraulic control circuit for a hydraulic on-vehicle winch comprises a winch control circuit interposed between a main circuit pressure inlet and the hydraulic connectors on the winch and governed by a pilot-operated directional valve. When a reel-out pilot valve shifts the pilot-operated directional valve, hydraulic flow to a reel-out port is permitted while flow to a reel-in port is obstructed. Conversely, when a reel-in pilot valve shifts the pilot-operated directional valve, hydraulic flow to the reel-in port is permitted while flow to the reel-out port is obstructed. A selectively configurable enabling circuit is interposed between the main circuit pressure inlet and the winch control circuit. In an enabling configuration, hydraulic flow from the main circuit pressure inlet to the pilot-operated directional valve, the reel-out pilot valve and the reel-in pilot valve is permitted. In a disabling configuration in which hydraulic flow to the pilot-operated directional valve is obstructed.

### TECHNICAL FIELD

The present disclosure relates to hydraulic winch systems mounted on a vehicle, and more particularly to hydraulic control systems for such winches.

### BACKGROUND

It is common to mount a hydraulic winch system onto a vehicle where the vehicle includes an onboard hydraulic system. For example on a light armored vehicle (LAV) intended for use in military or law enforcement applications may be provided with a hydraulically driven winch. It is desirable to integrate such a hydraulic winch with the onboard hydraulic system of the vehicle.

### SUMMARY

In one aspect, the present disclosure is directed to a hydraulic control circuit for a hydraulic on-vehicle winch. The hydraulic control circuit comprises a main circuit pressure inlet connectible in fluid communication with a source of pressurized hydraulic fluid, a reel-out port connectible in fluid communication with a reel-out connector of the winch, a reel-in port connectible in fluid communication with a reel-in connector of the winch, and a winch control circuit. The winch control circuit is hydraulically interposed between the main circuit pressure inlet and the reel-out port and between the main circuit pressure inlet and the reel-in port and operable to selectively supply pressurized hydraulic fluid from the main circuit pressure inlet to one of the reel-out port and the reel-in port. The winch control circuit is governed by a pilot-operated directional valve in fluid communication with a reel-out pilot valve, a reel-in pilot valve and the main circuit pressure inlet. When the reel-out pilot valve supplies hydraulic pressure to the pilot-operated directional valve, hydraulic fluid flow from the main circuit pressure inlet to the reel-out port is permitted while hydraulic fluid flow from the main circuit pressure inlet to the reel-in port is obstructed. When the reel-in pilot valve supplies hydraulic pressure to the pilot-operated directional valve, hydraulic fluid flow from the main circuit pressure inlet to the reel-in port is permitted while hydraulic fluid flow from the main circuit pressure inlet to the reel-out port is obstructed. An enabling circuit is hydraulically interposed between the main circuit pressure inlet and the winch control circuit and selectively configurable between an enabling configuration and a disabling configuration. In the enabling configuration, hydraulic fluid flow from the main circuit pressure inlet to the pilot-operated directional valve, the reel-out pilot valve and to the reel-in pilot valve is permitted, and in the disabling configuration hydraulic fluid flow from the main circuit pressure inlet to the pilot-operated directional valve is obstructed.

The hydraulic control circuit may further comprise a tank return outlet connectible in fluid communication with a hydraulic fluid return tank coupling. In such an embodiment, the winch control circuit is further coupled in fluid communication with the tank return outlet, and the winch control circuit is configured so that when the reel-out pilot valve supplies hydraulic pressure to the pilot-operated directional valve, hydraulic fluid flow from the winch into the reel-in port is directed to the hydraulic fluid return tank coupling, and when the reel-in pilot valve supplies hydraulic pressure to the pilot-operated directional valve, hydraulic fluid flow from the winch into the reel-out port is directed to the hydraulic fluid return tank coupling.

The hydraulic control circuit may further comprise a case drain outlet connectible in fluid communication with a hydraulic fluid tank and a case drain inlet connectible in fluid communication with a winch case drain connector, with the case drain inlet in fluid communication with the case drain outlet.

The hydraulic control circuit may further comprise a load sense port connectible in fluid communication with a load sense inlet on the vehicle. The enabling circuit is configured to supply pressurized hydraulic fluid to the load sense port, with the pressurized hydraulic fluid supplied to the load sense port being at a pressure representative of a load-induced pressure at an inlet of the winch control circuit.

The enabling circuit may comprise an enabling circuit pressure inlet in fluid communication with the main circuit pressure inlet, a pilot valve outlet in fluid communication with the reel-out pilot valve and the reel-in pilot valve, a directional valve outlet in fluid communication with the pilot-operated directional valve, a drain outlet, a vented logic element, an enable valve, and a pressure relief valve. The enabling circuit pressure inlet is in fluid communication with the pilot valve outlet, and the vented logic element is hydraulically interposed, downstream of a fluid communication coupling between the enabling circuit pressure inlet and the pilot valve outlet, between the enabling circuit pressure inlet and the directional valve outlet and also between the enabling circuit pressure inlet and a sink. The enable valve is interposed between the vented logic element and the drain and the pressure relief valve is interposed between the enable valve and the drain. When the enable valve is in an open configuration, the enabling circuit is in the enabling configuration and the vented logic element can vent through the enable valve and then through the relief valve to the sink, whereby pressurized hydraulic fluid can flow through the vented logic element to the directional valve outlet. When the enable valve is in a closed configuration, the enabling circuit is in the disabling configuration and venting of the vented logic element is obstructed, whereby pressurized hydraulic fluid flow through the vented logic element to the directional valve outlet is obstructed.

The vented logic element may be, for example, a spool-type logic element.

The sink may be, for example, a case drain outlet of the hydraulic circuit and the case drain outlet is connectible in fluid communication with the hydraulic fluid return coupling.

The hydraulic control circuit may further comprise a free spool port in fluid communication with the case drain outlet and connectable in fluid communication with a free spool connector on the winch and a free spool pilot valve hydraulically interposed between the free spool port and the case drain outlet and selectively configurable between a winding configuration and a free spooling configuration. In the winding configuration, flow of hydraulic fluid from the free spool port to the case drain outlet is permitted, and in the free spooling configuration, hydraulic fluid is supplied to the free spool port and flow of hydraulic fluid from the free spool port to the case drain outlet is obstructed.

The hydraulic control circuit may further comprise a brake release port in fluid communication with the case drain outlet and connectible in fluid communication with a brake release connector on the winch. The reel-out pilot valve may be hydraulically interposed between the brake release port and the case drain outlet. In such an arrangement, when the reel-out pilot valve supplies hydraulic pressure to the pilot-operated directional valve, hydraulic fluid flow from the brake release port to the case drain outlet is obstructed and hydraulic fluid flow to the brake release port from the main circuit pressure inlet is permitted, and when the reel-out pilot valve obstructs hydraulic pressure to the pilot-operated directional valve, hydraulic fluid flow from the brake release port to the case drain outlet is permitted and hydraulic fluid flow to the brake release port from the main circuit pressure inlet is obstructed.

A pilot operated pressure-reducing valve assembly may be hydraulically interposed between a main inlet of the winch control circuit inlet and a primary inlet of the pilot-operated directional valve. A fluid line may connect from between the pilot operated pressure-reducing valve assembly and the pilot-operated directional valve in valve-governed fluid communication with the tank return outlet.

A pressure-limiting valve may be hydraulically interposed between the pilot valve outlet and the reel-out pilot valve and between the pilot valve outlet and the reel-in pilot valve. The pressure-limiting valve may also be hydraulically interposed between the pilot valve outlet and the free spool pilot valve.

A counterbalance valve may be hydraulically interposed between the pilot-operated directional valve and the reel-in port, with the counterbalance valve having a reel-in port fluid aperture connected in fluid communication with the reel-in port, a pilot-operated directional valve fluid aperture connected in fluid communication with the pilot-operated directional valve, and a pilot pressure inlet connected in fluid communication with the reel-out port. The counterbalance valve may be configured so that when pressure exceeding a counterbalance valve threshold is supplied to the pilot pressure inlet from the reel-out port, hydraulic fluid flow from the reel-in port through the counterbalance valve to the pilot-operated directional valve is permitted, and when pressure supplied from the reel-out port to the pilot pressure inlet is below the counterbalance valve threshold, hydraulic fluid flow from the reel-in port through the counterbalance valve to the pilot-operated directional valve is obstructed.

### BRIEF DESCRIPTION OF THE DRAWINGS

These and other features will become more apparent from the following description in which reference is made to the appended drawing wherein:

FIG. 1 is a schematic diagram of a first illustrative embodiment of a hydraulic control system according to an aspect of the present disclosure;

FIG. 1A is a schematic diagram of a second illustrative embodiment of a hydraulic control system according to an aspect of the present disclosure;

FIG. 2 shows an illustrative handheld, cabled pendant containing toggle switches for controlling the hydraulic control system of FIG. 1;

FIG. 3 is a perspective view showing an illustrative enabling manifold for housing components of an enabling circuit;

FIG. 4 is a perspective view showing an illustrative control manifold for housing components of a winch control circuit according to the first illustrative embodiment;

FIG. 4A is a perspective view showing an illustrative control manifold for housing components of a winch control circuit according to the second illustrative embodiment; and

FIG. 5 is a perspective view showing the enabling manifold of FIG. 3 and the control manifold of FIG. 4 in their mounted positions relative to a hydraulic winch assembly.

### DETAILED DESCRIPTION

Throughout the specification, references to specific model numbers of valves and other components, unless otherwise specified, refer to those offered by HydraForce, Inc., having an address at 500 Barclay Blvd., Lincolnshire, Ill. 60069 USA, and are merely examples for purposes of illustration and are not intended to be limiting. The illustrated embodiment is intended to operate with an input hydraulic flow rate of about 12-40 GPM, with a tank line pressure of about 50-800 PSI depending on the flow rate (higher flow rates result in higher pressure); again these are merely illustrative example values and are not intended to be limiting.

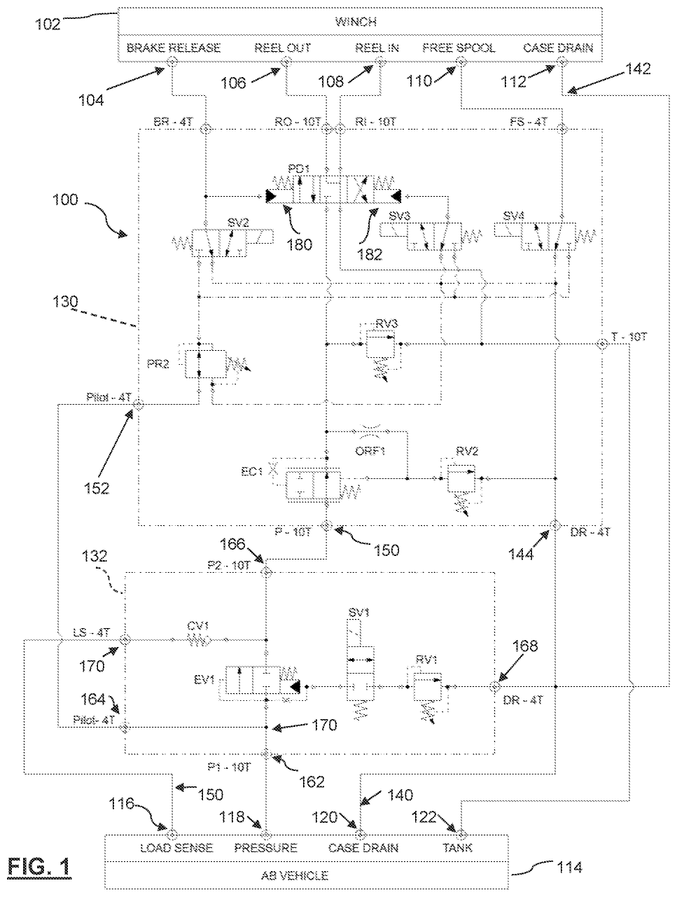

Reference is now made to FIG. 1, which is a schematic diagram of a first illustrative hydraulic control circuit 100 for a hydraulic on-vehicle winch. In FIG. 1, port size and thread type are designated at the indicated connections as follows:
4T=−4 SAE O-ring Boss (SAE J1926/1)
10T=−10 SAE O-ring Boss (SAE J1926/1)
   These are merely examples, and are not intended to be limiting.

The winch is illustrated schematically by the rectangular box 102 at the upper portion of FIG. 1. The illustrated winch 102 includes a brake release connector 104, a reel-out connector of 106, a reel-in connector 108, a free spool connector 110 and a case drain connector 112. This is merely an illustrative embodiment of a winch, and hydraulic control circuits according to aspects of the present disclosure may be used with other winches. For example, some winches may not include a brake release connector and/or free spool connector. The winch 102 is described and illustrated solely for the purpose of explaining operation of the hydraulic control circuit 100, and does not form part of the invention as claimed.

The hydraulic control circuit 100 integrates the winch 102 with the on-board hydraulic system of a vehicle, illustrated schematically by the rectangular box 114 at the lower portion of FIG. 1. The on-board hydraulic system of the vehicle 114 includes a load sense inlet 116, a source of pressurized hydraulic fluid 118, a case drain coupling 120 and a hydraulic fluid return tank coupling 122 that communicates with a hydraulic fluid tank on the vehicle. Typically, hydraulic fluid received at the case drain coupling 120 is recycled to the hydraulic fluid tank. The on-board hydraulic system of the vehicle 114 is described and illustrated solely for the purpose of explaining operation of the hydraulic control circuit 100, and does not form part of the invention as claimed. Again, the illustrated on-board hydraulic system of the vehicle 114 is merely an illustrative embodiment, and hydraulic control circuits according to aspects of the present disclosure may be used with other hydraulic systems. For example, some hydraulic systems may not include a load sense inlet.

The hydraulic control circuit 100 comprises a main circuit pressure inlet P1 connectible in fluid communication with the source of pressurized hydraulic fluid 118, a reel-out port RO connectible in fluid communication with the reel-out connector 106 of the winch 102 and a reel-in port RI connectible in fluid communication with the reel-in connector 108 of the winch 102.

The hydraulic control circuit 100 comprises a winch control circuit, denoted by upper dashed box 130. The winch control circuit 130 is hydraulically interposed between the main circuit pressure inlet P1 and the reel-out port RO and between the main circuit pressure inlet P1 and the reel-in port RI. The winch control circuit 130 is operable to selectively supply pressurized hydraulic fluid from the main circuit pressure inlet P1 to one of the reel-out port RO and the reel-in port RI and thereby control operation of the winch 102.

The winch control circuit 130 is governed by a pilot-operated directional valve PD1, which is in fluid communication with a reel-out pilot valve SV2 and a reel-in pilot valve SV3 and with the main circuit pressure inlet P1 (as described further below). The reel-out pilot valve SV2 controls the reel-out function of the winch 102 and, the reel-in pilot valve SV3 controls the reel-in function of the winch 102. Where a brake/brake release function is present, the reel-out pilot valve SV2 may control this function as well, as described further below. In the illustrated embodiment, the pilot-operated directional valve PD1 is a pilot-operated, spool-type hydraulic directional valve, for example model HPD42-S67D-0-U-170 and the reel-out pilot valve SV2 and the reel-in pilot valve SV3 are both solenoid-operated, 3-way, direct-acting, spool-type directional valves, for example model SV58-30-0-P-24ER/Z. These are merely illustrative examples and are not intended to be limiting.

When the reel-out pilot valve SV2 supplies hydraulic pressure to the pilot-operated directional valve PD1, hydraulic fluid flow from the main circuit pressure inlet P1 to the reel-out port RO is permitted, via the pilot-operated directional valve PD1, while hydraulic fluid flow from the main circuit pressure inlet P1 to the reel-in port RI is obstructed. Conversely, when the reel-in pilot valve SV3 supplies hydraulic pressure to the pilot-operated directional valve PD1, hydraulic fluid flow from the main circuit pressure inlet P1 to the reel-in port RI is permitted through the pilot-operated directional valve PD1, while hydraulic fluid flow from the main circuit pressure inlet P1 to the reel-out port RO is obstructed.

The hydraulic control circuit 100 also comprises an enabling circuit, denoted by lower dashed box 132. The enabling circuit 132 is hydraulically interposed between the main circuit pressure inlet P1 and the winch control circuit 130. The enabling circuit 132 is selectively configurable between an enabling configuration and a disabling configuration. When the enabling circuit 132 is in the enabling configuration, hydraulic fluid flow from the main circuit pressure inlet P1 to the pilot-operated directional valve PD1, to the reel-out pilot valve SV2 and to the reel-in pilot valve SV3 is permitted. When the enabling circuit 132 is in the disabling configuration, hydraulic fluid flow from the main circuit pressure inlet P1 to the pilot-operated directional valve PD1 is obstructed, although hydraulic fluid flow from the main circuit pressure inlet P1 to the reel-out pilot valve SV2 and to the reel-in pilot valve SV3 may be permitted.

In the illustrated embodiment, the hydraulic control circuit 100 further comprises a tank return outlet T connectible in fluid communication with the hydraulic fluid return tank coupling 122, and the winch control circuit 130 is further coupled in fluid communication with the tank return outlet T. The winch control circuit 130 is configured to return the pressurized hydraulic fluid supplied to the winch 102 to drive rotation of the winch drum (i.e. reel-in and reel-out operation) back to the tank return outlet T. In this regard, it is contemplated that pressurized hydraulic fluid supplied to the reel-out connector 106 will, after driving rotation of the winch drum, be directed to flow out of from the reel-in connector 108. Likewise, it is contemplated that that pressurized hydraulic fluid supplied to the reel-in connector 108 will, after driving rotation of the winch drum, be directed to flow out of the reel-out connector 106.

When the reel-out pilot valve SV2 supplies hydraulic pressure to the pilot-operated directional valve PD1, hydraulic fluid flows through the reel-out port RO into the reel out connector 106, through the winch 102 and then the reel-in connector 108 into the reel-in port RI. This fluid is then directed through the pilot-operated directional valve PD1 to the tank return outlet T and then to the hydraulic fluid return tank coupling 122. Similarly, when the reel-in pilot valve SV3 supplies hydraulic pressure to the pilot-operated directional valve PD1, hydraulic fluid flows through the reel-in port RI into the reel-in connector 108, through the winch 102 and then the reel-out connector 106 into the reel-out port RO, and is then is directed through the pilot-operated directional valve PD1 to the tank return outlet T and then to the hydraulic fluid return tank coupling 122.

In the illustrated embodiment, the hydraulic control circuit 100 further comprises a case drain outlet 140 connectible in fluid communication with the hydraulic fluid tank. For example, where the on-board hydraulic system of the vehicle provides for hydraulic fluid received at the case drain coupling 120 to be recycled to the hydraulic fluid tank, the case drain outlet 140 may be connectible in fluid communication with the case drain coupling 120. The illustrated hydraulic control circuit 100 further comprises a case drain inlet 142 connectible in fluid communication with the winch case drain connector 112, and the case drain inlet 142 is in fluid communication with the case drain outlet 140.

The illustrated hydraulic control circuit 100 further comprises a free spool port FS connectible in fluid communication with the free spool connector 110 and also in fluid communication with a sink. In the illustrated embodiment, the sink is the case drain outlet 140 and connection is by way of a winch control circuit drain outlet 144. A free spool pilot valve SV4 is hydraulically interposed between the free spool port FS and the case drain outlet 140 and selectively configurable between a winding configuration and a free spooling configuration. In the winding configuration, flow of hydraulic fluid from the free spool port FS to the case drain outlet 140 is permitted. It is contemplated that when no hydraulic fluid is supplied to the free spool connector 110, a free spool actuator in the winch 102 is biased into a configuration in which pressurized hydraulic fluid supplied to the reel-out connector 106 or the reel-in connector 108 will drive rotation of the drum. In the free spooling configuration, hydraulic fluid is supplied to the free spool port FS through the free spool pilot valve SV4 and flow of hydraulic fluid from the free spool port FS to the case drain outlet 140 is obstructed. This leaves the winch 102 in a default condition where the winch drum can be driven by hydraulic flow but does not rotate freely. When hydraulic fluid is supplied to the free spool connector 110, the free spool actuator in the winch 102 will be moved into a configuration in which the drum can freely rotate. The free spool pilot valve SV4 may be, for example, a solenoid-operated, 3-way, direct-acting, spool-type directional valve, for example model SV58-30-0-P-24ER/Z. This is merely an illustrative example and is not intended to be limiting. Where the winch does not include a free spool feature, the corresponding aspects of the hydraulic control circuit 100 may be omitted.

In the illustrated embodiment, the hydraulic control circuit 100 further comprises a brake release port BR in fluid communication with the sink and connectible in fluid communication with the brake release connector 104 on the winch 102. As noted above, in the illustrated embodiment the sink is the case drain outlet 140, with connection via the winch control circuit drain outlet 144, although other configurations are also contemplated. The reel-out pilot valve SV2 is hydraulically interposed between the brake release port BR and the case drain outlet 140. It is contemplated that when no hydraulic fluid is supplied to the brake release connector 104, a on the winch 102, for example a sprag clutch, will be engaged, and when hydraulic fluid is supplied to the brake release connector 104, the brake will be disengaged. The sprag clutch is merely one example of a brake, and is not intended to be limiting. When the reel-out pilot valve SV2 supplies hydraulic pressure to the pilot-operated directional valve PD1, hydraulic fluid flow from the brake release port BR to the case drain outlet is obstructed and hydraulic fluid also flows into the brake release connector 104 to disengage the brake. When the reel-out pilot valve SV2 obstructs hydraulic pressure to the pilot-operated directional valve PD1, hydraulic fluid flow from the brake release port BR to the case drain outlet 140 is also obstructed, and the ratchet-brake will engage. Where the winch does not include a brake, the corresponding aspects of the hydraulic control circuit 100 may be omitted.

In the illustrated hydraulic control circuit 100, the enabling circuit 132 comprises an enabling circuit pressure inlet 162, a pilot valve outlet 164, a directional valve outlet 166, an enabling circuit drain outlet 168, a load sense port 170, a vented logic element EV1, an enable valve SV1 and a pressure relief valve RV1. The directional valve outlet 166 is in fluid communication with the main inlet 150 of the winch control circuit 130, and thereby in fluid communication, through an on-demand pressure compensator valve EC1 (described further below) with the pilot-operated directional valve PD1. The enabling circuit drain outlet 168 is in fluid communication with the case drain outlet 140.

The load sense port 170 is connectible in fluid communication with the load sense inlet 116 on the vehicle. The enabling circuit 132 is configured to supply pressurized hydraulic fluid to the load sense port 170. The pressurized hydraulic fluid supplied to the load sense port 170 is at a pressure representative of a load-induced pressure at the main inlet 150 of the winch control circuit 130. The main inlet 150 is the inlet that receives the pressurized hydraulic fluid to be supplied to the reel-out connector 106 and reel-in connector 108 on the winch 102, as distinguished from the pilot valve inlet 152. The pilot valve inlet 152 receives the pressurized hydraulic fluid that will be supplied to the pilot valves SV2, SV3 and SV4, and is coupled in fluid communication with the pilot valve outlet 164 to receive pressurized hydraulic fluid therefrom.

The enabling circuit pressure inlet 162 is in fluid communication with the pilot valve outlet 164, and the vented logic element EV1 is disposed downstream of a fluid communication coupling between the enabling circuit pressure inlet 162 and the pilot valve outlet 164. The vented logic element EV1 is hydraulically interposed between the enabling circuit pressure inlet 162 and the directional valve outlet 166. The pressurized hydraulic fluid supplied to the directional valve outlet 166 is also fed, through a check valve CV1 to prevent back flow, to the load sense port 170. The vented logic element EV1 is further hydraulically interposed between the enabling circuit pressure inlet 162 and the sink, in this instance the case drain outlet 140 via the enabling circuit drain outlet 168. The enable valve SV1 is interposed between the vented logic element EV1 and the case drain outlet 140, and the pressure relief valve RV1 is interposed between the enable valve SV1 and the case drain outlet 140. As can be seen, in the illustrated embodiment the enable valve SV1 is interposed between the vented logic element EV1 and the enabling circuit drain outlet 168, and the pressure relief valve RV1 is interposed between the enable valve SV1 and the enabling circuit drain outlet 168. The enabling circuit drain outlet 168 then feeds to the case drain outlet 140.

In the illustrated embodiment, the vented logic element EV1 is a spool-type logic element in the form of a high flow pilot operated valve and the enable valve SV1 is a solenoid operated, 2-way, normally closed, direct-acting spool-type directional valve. The vented logic element EV1 cooperates with the enable valve SV1 to move the enabling circuit 132 between the enabling configuration and the disabling configuration and the pressure relief valve RV1 sets the minimum pressure for the winch control circuit 130.

When the enable valve SV1 is in an open configuration, the enabling circuit 132 is in the enabling configuration. When the enabling circuit 132 is in the enabling configuration, the vented logic element EV1 can vent through the enable valve SV1 and then through the relief valve RV1 to the case drain outlet 140. This enables pressurized hydraulic fluid to flow through the vented logic element EV1 to the directional valve outlet 166 and then to the main inlet 150 of the winch control circuit 130.

When the enable valve SV1 is in a closed configuration, the enabling circuit 132 is in the disabling configuration. When the enabling circuit 132 is in the disabling configuration, venting of the vented logic element EV1 is obstructed by the closed enable valve SV1, with the result that pressurized hydraulic fluid flow to the directional valve outlet 166 is obstructed by the vented logic element EV1.

Thus, when the enabling circuit 132 is in the enabling configuration, hydraulic fluid flow from the main circuit pressure inlet P1 to the main inlet 150 of the winch control circuit 130, and thereby to the pilot-operated directional valve PD1, is permitted. At least in the enabling configuration, hydraulic fluid flow from the main circuit pressure inlet P1 to the pilot valve inlet 152 and thereby to the reel-out pilot valve SV2 and to the reel-in pilot valve SV1 is also permitted. Conversely, when the enabling circuit 132 is in the disabling configuration, hydraulic fluid flow from the main circuit pressure inlet P1 to the main inlet 150 of the winch control circuit 130, and hence to the pilot-operated directional valve PD1, is obstructed.

In the illustrated embodiment, the vented logic element EV1 may be, for example, model EV12-S34-0-N-100. Other types of vented logic elements may be used in alternate embodiments; for example, a poppet-type valve may be used with suitable modification of the hydraulic control circuit. The enable valve SV1 may be, for example, model SV58-24-0-P-24ER and the pressure relief valve RV1 may be, for example, model RV50-22H-0-P-50/5.0. The check valve CV1 may be, for example, model HCV06-20-U-05. These are merely examples and are not intended to be limiting.

Pressurized hydraulic fluid received at the pilot valve inlet 152 from the pilot valve outlet 164 passes through a pressure-reducing valve PR2, which sets the maximum pressure in the pilot circuit portion of the winch control circuit 130. The pressure-reducing valve PR2 is hydraulically interposed between the pilot valve inlet 152 and the pilot valves, that is, the reel-out pilot valve SV2, the reel-in pilot valve SV3 and the free spool pilot valve SV4. Thus, a pressure-limiting valve (pressure-reducing valve PR2) is hydraulically interposed between the pilot valve outlet 164 and the reel-out pilot valve SV2, between the pilot valve outlet 164 and the reel-in pilot valve SV3, and between the pilot valve outlet 164 and the free spool pilot valve SV4. Since the spring chamber of the pressure-reducing valve PR2 is referencing the case drain outlet 140, the tank pressures have no effect on its setting and the pressure-reducing valve PR2 will provide stable pressure throughout the operating flow range. The pressure-reducing valve PR2 may be, for example, model PR58-38H-0-P-20/7.0, and in the illustrated embodiment, the pressure-reducing valve PR2 steps down the pressure to about 700 PSI; these are merely examples and are not intended to be limiting.

Pressurized hydraulic fluid received at the main inlet 150 from the directional valve outlet 166 passes through an on-demand pressure compensator valve EC1, which serves as a high flow pilot operated pressure-reducing valve. The on-demand pressure compensator valve EC1 is hydraulically interposed between the main inlet 150 and the pilot-operated directional valve PD1, and may be, for example, model HEC16-32-0-U-80. This is merely an example and is not intended to be limiting. A pressure relief valve RV2 is hydraulically interposed between the on-demand pressure compensator valve EC1 and the case drain outlet 140, in this case between the on-demand pressure compensator valve EC1 and the winch control circuit drain outlet 144. The pressure relief valve RV2 sets the pressure for the on-demand pressure compensator valve EC1, and may be, for example, model RV58-20H-0-P46/34.0. This is merely an example and is not intended to be limiting. An orifice ORF1 enables fluid communication from a position between the on-demand pressure compensator valve EC1 and the pilot-operated directional valve PD1 to a position between the on-demand pressure compensator valve EC1 and the pressure relief valve RV2, and may be, for example, a 0.025 inch diameter orifice. This is merely an example and is not intended to be limiting. Thus, in the illustrated embodiment a pilot operated pressure-reducing valve assembly (on-demand pressure compensator valve EC1, pressure relief valve RV2 and orifice ORF1) is interposed between the main inlet 150 of the winch control circuit 130 and the primary inlet of the pilot-operated directional valve PD1. This sets the pressure for the pilot-operated directional valve PD1. In the illustrated embodiment, this pressure is set to about 3400 PSI although this is merely one example and is not intended to be limiting.

Fluid communication from a position between the on-demand pressure compensator valve EC1 and the pilot-operated directional valve PD1, downstream of the orifice ORF1, to the tank return outlet T is governed by a pressure relief valve RV3. This is to obviate pressure spikes. Thus, in the illustrated embodiment an overpressure valve governs a fluid line which connects between the pilot operated pressure-reducing valve assembly (on-demand pressure compensator valve EC1, pressure relief valve RV2 and orifice ORF1) and the pilot-operated directional valve PD1, in valve-governed fluid communication with the tank return outlet T.

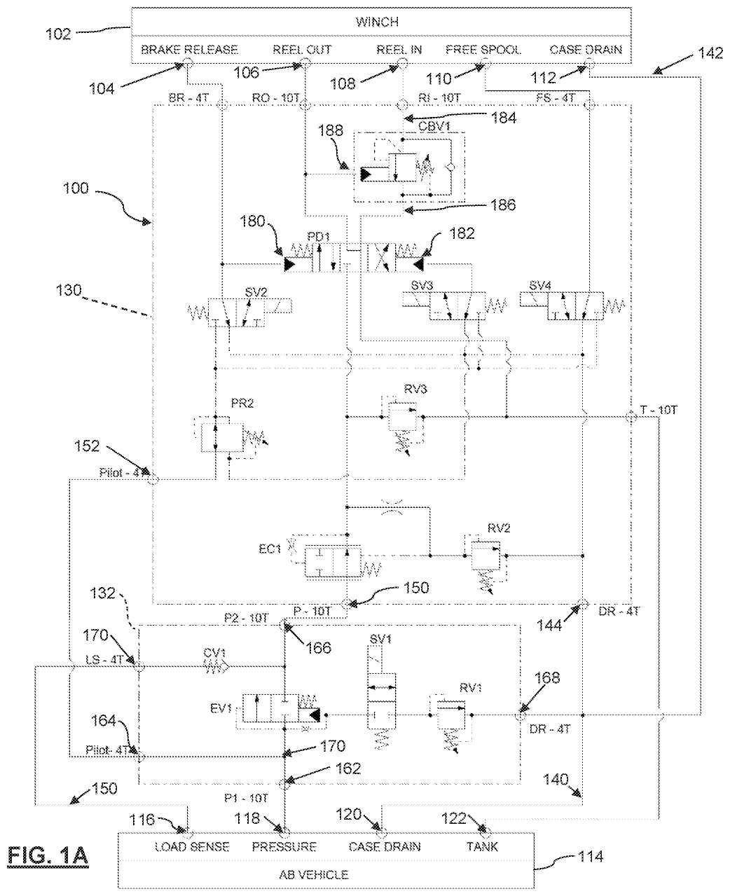

The solenoid valves SV1, SV2, SV3 and SV4 and hence the hydraulic control circuit 100, may controlled by suitable actuators in a control interface. Once such control interface is a handheld, cabled pendant containing toggle switches, an illustrative implementation of which is shown in FIG. 2 and indicated generally at reference 200. The pendant 200 includes an enable switch 202, a reel control switch 204 and a free spool switch 208. The enable switch 202 is in electrical communication with the enable valve SV1, the reel control switch 204 is in electrical communication with the reel-out pilot valve SV2 and the reel-in pilot valve SV3, and the free spool switch 208 is in electrical communication with the free spool pilot valve SV4.

When the enable switch 202 is in the “disable” position, no voltage flows to the coil on the enable valve SV1, which remains closed. This leaves the enabling circuit 132 in the disabling configuration, in which hydraulic fluid flow from the main circuit pressure inlet P1 to the main inlet 150 of the winch control circuit 130, and hence to the pilot-operated directional valve PD1, is obstructed by the enabling circuit 132.

When the enable switch 202 is flipped to the “enable” position, voltage is sent to the coil on the enable valve SV1. This opens the enable valve SV1, allowing hydraulic fluid from the vented logic element EV1 to vent and placing the enabling circuit 132 in the enabling configuration. With the enabling circuit 132 in the enabling configuration, hydraulic fluid flow from the main circuit pressure inlet P1 through the enabling circuit 132 to the main inlet 150 of the winch control circuit 130, and thereby to the pilot-operated directional valve PD1, is permitted. The pressure setting on the relief valve RV1 and the spring bias in the vented logic element EV1 set the minimum system pressure. In the illustrated embodiment, target pressure is about 600 PSI although this is merely an example and is not intended to be limiting.

When the enable switch 202 is flipped to the “enable” position, placing the enabling circuit 132 in the enabling configuration, and the reel control switch 204 is moved to the “reel-out” position, voltage is applied to the solenoid on the reel-out pilot valve SV2. This opens the reel-out pilot valve SV2, which causes hydraulic fluid to flow through the brake release port BR to the brake release connector 104. The open reel-out pilot valve SV2 also supplies hydraulic fluid to the reel-out port 180 of the pilot-operated directional valve PD1, which shifts to deliver pressurized hydraulic fluid to the reel-out port RO and thereby to the reel-out connector 106 on the winch 102 to drive the winch motor. The pressurized hydraulic fluid can be supplied to the brake release connector 104 and the reel-out port 180 of the pilot-operated directional valve PD1 at, for example, about 700 PSI, although this is merely an example and not limiting. The pilot operated pressure-reducing valve assembly (on-demand pressure compensator valve EC1, pressure relief valve RV2 and orifice ORF1 in cooperation) limit the maximum pressure to the value of (a) the setting of the pressure relief valve RV2 added to (b) the spring rate of the on-demand pressure compensator valve EC1. This will be a restrictive pressure control and is referencing the case drain to make the setting immune to the tank pressure. The pressure is further controlled by the pressure relief valve RV3.

When the enable switch 202 is flipped to the “enable” position to place the enabling circuit 132 in the enabling configuration, and the reel control switch 204 is moved to the “reel-in” position, voltage is applied to the solenoid on the reel-in pilot valve SV3, opening the reel-in pilot valve SV3. The open reel-out pilot valve SV3 then allows hydraulic fluid to flow to the reel-in port 182 of the pilot-operated directional valve PD1, for example at about 700 PSI. This causes the pilot-operated directional valve PD1 to shift to deliver pressurized hydraulic fluid to the reel-in port RI and thereby to the reel-in connector 108 on the winch 102, driving the winch motor. As with the reel-out mode, the pilot operated pressure-reducing valve assembly (on-demand pressure compensator valve EC1, pressure relief valve RV2 and orifice ORF1 in cooperation) limits the maximum pressure, and the pressure is further controlled by the pressure relief valve RV3.

When the enable switch 202 is flipped to the “enable” position, placing the enabling circuit 132 in the enabling configuration, and the free spool switch 208 is activated, voltage is applied to the solenoid on the free spool pilot valve SV4. This opens the free spool pilot valve SV4 to deliver hydraulic fluid to the free spool port FS, for example at about 700 PSI, and thereby to the free spool connector 110 on the winch.

FIG. 1A shows an alternate embodiment of a hydraulic control circuit according to the present disclosure. The hydraulic control circuit shown in FIG. 1A is identical to that shown in FIG. 1, save for the addition of a counterbalance valve CBV1, which is hydraulically interposed between the pilot-operated directional valve PD1 and the reel-in port RI. Thus, like references denote like features in FIGS. 1 and 1A.

The counterbalance valve CBV1 has a reel-in port fluid aperture 184, a pilot-operated directional valve fluid aperture 186 and a pilot pressure inlet 188. The reel-in port fluid aperture 184 is connected in fluid communication with the reel-in port RI, the pilot-operated directional valve fluid aperture 186 is connected in fluid communication with the pilot-operated directional valve PD1 and the pilot pressure inlet 188 is connected in fluid communication with the reel-out port RO. The counterbalance valve CBV1 is configured so that when pressure exceeding a counterbalance valve threshold is supplied to the pilot pressure inlet 188 thereof from the reel-out port RO, hydraulic fluid flow from the reel-in port RI through the counterbalance valve CBV1 to the pilot-operated directional valve PD1 is permitted. The counterbalance valve CBV1 is further configured so that when pressure supplied from the reel-out port RO to the pilot pressure inlet 188 is below the counterbalance valve threshold, hydraulic fluid flow from the reel-in port RI through the counterbalance valve CBV1 to the pilot-operated directional valve PD1 is obstructed. The counterbalance valve may be, for example, a model CBGALHN valve offered by Sun Hydraulics LLC, having an address at 1500 West University Parkway, Sarasota, Fla. 34243, USA. This is merely an illustrative example and is not intended to be limiting.

With certain types of winch cables and anchoring arrangements, heavy loads can induce an elastic tension into the winch cable during reel-in operations. Without a counterbalance valve, during the transition to reel-out operations, the sudden release of tension can lead to over-rotation of the winch drum in the reel-out direction, which can damage mechanical components. Without promising any particular utility, it is believed that in some applications the counterbalance valve CBV1 may enhance control during reel-out operations and protect the winch components when under heavy loads. Where the winch cable and anchoring is not susceptible of excessive elastic tension under anticipated loads, the counterbalance valve CBV1 may be omitted; however the counterbalance valve CBV1 may also limit acceleration during reel-out operation by imposing valve-controlled dynamic braking, which may be desirable in some applications (independent of winch cable tension issues).

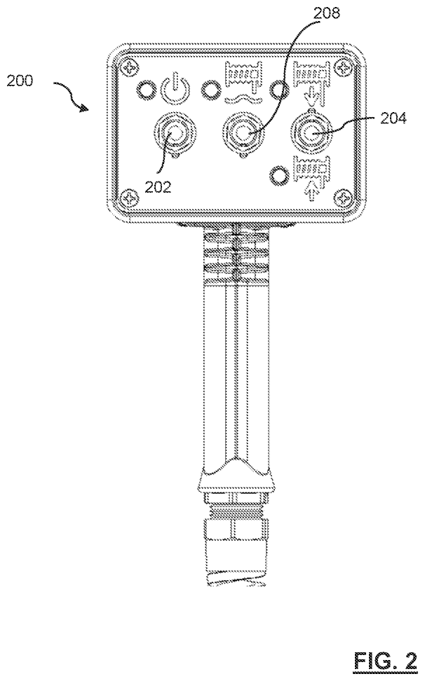

FIG. 3 shows an illustrative enabling manifold, indicated generally at reference 300, for housing the components of the enabling circuit 132, including the enable valve SV1, the vented logic element EV1, the check valve CV1 and the relief valve RV1.

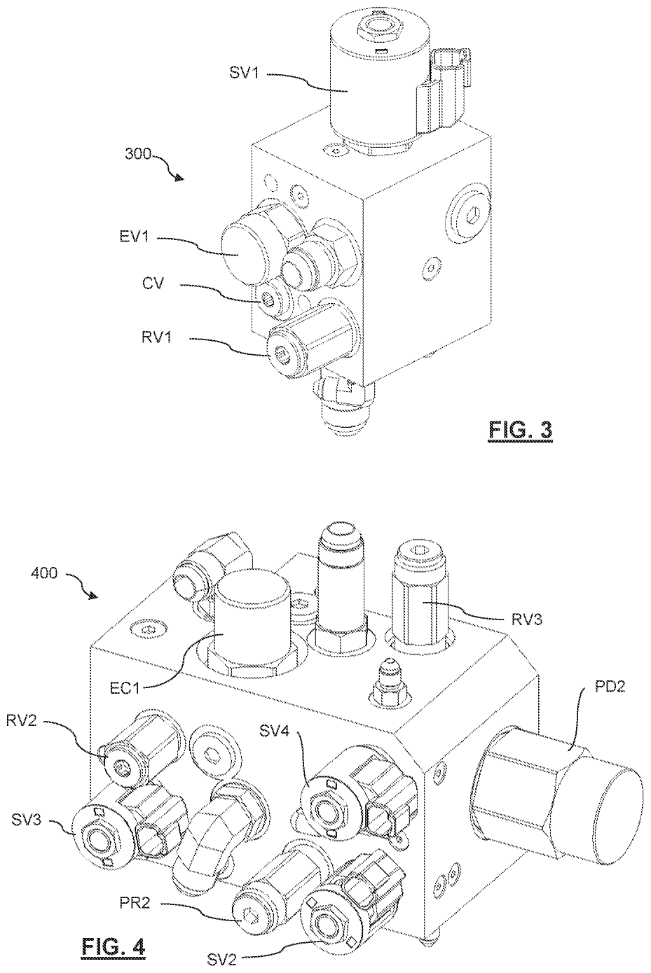

FIG. 4 shows an illustrative control manifold, indicated generally at reference 400, for housing the components of the first illustrative winch control circuit 130 shown in FIG. 1, including the on-demand pressure compensator valve EC1, pilot-operated directional valve PD1, pressure-reducing valve PR2, pressure relief valve RV2, pressure relief valve RV3, reel-out pilot valve SV2, reel-in pilot valve SV3 and free spool pilot valve SV4. FIG. 4A shows the control manifold for housing the winch control circuit 130 shown in FIG. 1A, further including the counterbalance valve CBV1. FIG. 4A shows an illustrative control manifold for housing the components of the second illustrative winch control circuit 130 shown in FIG. 1A, with like references denoting like features. The control manifold 400 shown in FIG. 4A further houses the counterbalance valve CBV1.

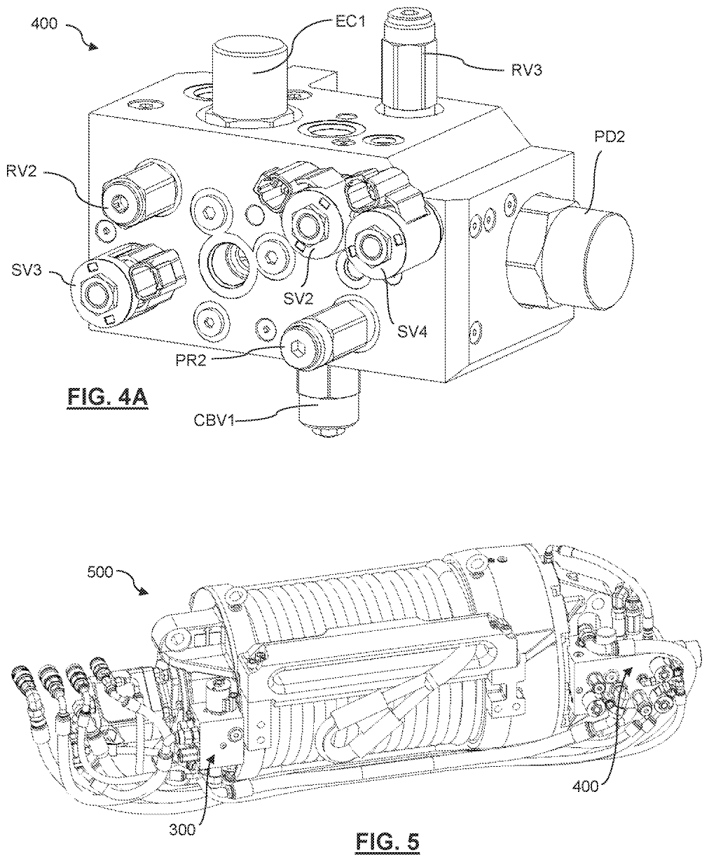

FIG. 5 shows the enabling manifold 300 and the control manifold 400 in their mounted positions relative to a hydraulic winch assembly, indicated generally at 500. The winch 102 may be, for example, a model PRD30B winch offered by Paccar Inc., having an address at 800 East Dallas Street, Broken Arrow, Okla. 74012 U.S.A. This is merely an example and is not intended to be limiting.

One or more currently preferred embodiments have been described by way of example. It will be apparent to persons skilled in the art that a number of variations and modifications can be made without departing from the scope of the claims.

What is claimed is:

1. A hydraulic control circuit for a hydraulic on-vehicle winch, comprising:
a main circuit pressure inlet connectible in fluid communication with a source of pressurized hydraulic fluid;
a reel-out port connectible in fluid communication with a reel-out connector of the winch;
a reel-in port connectible in fluid communication with a reel-in connector of the winch;
a winch control circuit hydraulically interposed between the main circuit pressure inlet and the reel-out port and between the main circuit pressure inlet and the reel-in port and operable to selectively supply pressurized hydraulic fluid from the main circuit pressure inlet to one of the reel-out port and the reel-in port;
the winch control circuit being governed by a pilot-operated directional valve in fluid communication with:
a reel-out pilot valve;
a reel-in pilot valve; and
the main circuit pressure inlet;
wherein:
when the reel-out pilot valve supplies hydraulic pressure to the pilot-operated directional valve, hydraulic fluid flow from the main circuit pressure inlet to the reel-out port is permitted while hydraulic fluid flow from the main circuit pressure inlet to the reel-in port is obstructed; and
when the reel-in pilot valve supplies hydraulic pressure to the pilot-operated directional valve, hydraulic fluid flow from the main circuit pressure inlet to the reel-in port is permitted while hydraulic fluid flow from the main circuit pressure inlet to the reel-out port is obstructed; and
an enabling circuit hydraulically interposed between the main circuit pressure inlet and the winch control circuit and selectively configurable between:
an enabling configuration in which hydraulic fluid flow from the main circuit pressure inlet to the pilot-operated directional valve, the reel-out pilot valve and to the reel-in pilot valve is permitted; and
a disabling configuration in which hydraulic fluid flow from the main circuit pressure inlet to the pilot-operated directional valve is obstructed.

2. The hydraulic control circuit of claim 1, further comprising:
a tank return outlet connectible in fluid communication with a hydraulic fluid return tank coupling;
wherein:
the winch control circuit is further coupled in fluid communication with the tank return outlet;
the winch control circuit is configured so that:
when the reel-out pilot valve supplies hydraulic pressure to the pilot-operated directional valve, hydraulic fluid flow from the winch into the reel-in port is directed to the hydraulic fluid return tank coupling; and
when the reel-in pilot valve supplies hydraulic pressure to the pilot-operated directional valve, hydraulic fluid flow from the winch into the reel-out port is directed to the hydraulic fluid return tank coupling.

3. The hydraulic control circuit of claim 1, further comprising:
a case drain outlet connectible in fluid communication with a hydraulic fluid tank; and
a case drain inlet connectible in fluid communication with a winch case drain connector;
wherein the case drain inlet is in fluid communication with the case drain outlet.

4. The hydraulic control circuit of claim 1, further comprising:
a load sense port connectible in fluid communication with a load sense inlet on the vehicle;
wherein the enabling circuit is configured to supply pressurized hydraulic fluid to the load sense port, wherein the pressurized hydraulic fluid supplied to the load sense port is at a pressure representative of a load-induced pressure at an inlet of the winch control circuit.

5. The hydraulic control circuit of claim 1, wherein the enabling circuit comprises:
an enabling circuit pressure inlet in fluid communication with the main circuit pressure inlet;
a pilot valve outlet in fluid communication with the reel-out pilot valve and the reel-in pilot valve;
a directional valve outlet in fluid communication with the pilot-operated directional valve;
a drain outlet;
a vented logic element;
an enable valve; and
a pressure relief valve;
wherein:
the enabling circuit pressure inlet is in fluid communication with the pilot valve outlet;
the vented logic element is hydraulically interposed, downstream of a fluid communication coupling between the enabling circuit pressure inlet and the pilot valve outlet:
between the enabling circuit pressure inlet and the directional valve outlet; and
between the enabling circuit pressure inlet and a sink; and
the enable valve being interposed between the vented logic element and the drain;
the pressure relief valve being interposed between the enable valve and the drain;
wherein:
when the enable valve is in an open configuration, the enabling circuit is in the enabling configuration wherein:
the vented logic element can vent through the enable valve and then through the relief valve to the sink;
whereby pressurized hydraulic fluid can flow through the vented logic element to the directional valve outlet; and
when the enable valve is in a closed configuration, the enabling circuit is in the disabling configuration wherein:
venting of the vented logic element is obstructed;
whereby pressurized hydraulic fluid flow through the vented logic element to the directional valve outlet is obstructed.

6. The hydraulic control circuit of claim 3, further comprising:
a free spool port in fluid communication with the case drain outlet and connectable in fluid communication with a free spool connector on the winch;
a free spool pilot valve hydraulically interposed between the free spool port and the case drain outlet and selectively configurable between:
a winding configuration in which flow of hydraulic fluid from the free spool port to the case drain outlet is permitted; and
a free spooling configuration in which hydraulic fluid is supplied to the free spool port and flow of hydraulic fluid from the free spool port to the case drain outlet is obstructed.

7. The hydraulic control circuit of claim 3, further comprising:
a brake release port in fluid communication with the case drain outlet and connectible in fluid communication with a brake release connector on the winch;
the reel-out pilot valve is hydraulically interposed between the brake release port and the case drain outlet;
when the reel-out pilot valve supplies hydraulic pressure to the pilot-operated directional valve, hydraulic fluid flow from the brake release port to the case drain outlet is obstructed and hydraulic fluid flow to the brake release port from the main circuit pressure inlet is permitted;
when the reel-out pilot valve obstructs hydraulic pressure to the pilot-operated directional valve, hydraulic fluid flow from the brake release port to the case drain outlet is permitted and hydraulic fluid flow to the brake release port from the main circuit pressure inlet is obstructed.

8. The hydraulic control circuit of claim 5, wherein the sink is a case drain outlet of the hydraulic circuit and the case drain outlet is connectible in fluid communication with the hydraulic fluid return coupling.

9. The hydraulic control circuit of claim 5, wherein the vented logic element is a spool-type logic element.

10. The hydraulic control circuit of claim 1, wherein a pilot operated pressure-reducing valve assembly is hydraulically interposed between a main inlet of the winch control circuit inlet and a primary inlet of the pilot-operated directional valve.

11. The hydraulic control circuit of claim 10, wherein a fluid line connects from between the pilot operated pressure-reducing valve assembly and the pilot-operated directional valve in valve-governed fluid communication with the tank return outlet.

12. The hydraulic control circuit of claim 5, wherein:
a pressure-limiting valve is hydraulically interposed:
between the pilot valve outlet and the reel-out pilot valve; and
between the pilot valve outlet and the reel-in pilot valve.

13. The hydraulic control circuit of claim 12, wherein the pressure-limiting valve is hydraulically interposed between the pilot valve outlet and the free spool pilot valve.

14. The hydraulic control circuit of claim 1, further comprising:
a counterbalance valve hydraulically interposed between the pilot-operated directional valve and the reel-in port;
the counterbalance valve having:
a reel-in port fluid aperture connected in fluid communication with the reel-in port;
a pilot-operated directional valve fluid aperture connected in fluid communication with the pilot-operated directional valve; and
a pilot pressure inlet connected in fluid communication with the reel-out port;
wherein the counterbalance valve is configured so that:
when pressure exceeding a counterbalance valve threshold is supplied to the pilot pressure inlet thereof from the reel-out port, hydraulic fluid flow from the reel-in port through the counterbalance valve to the pilot-operated directional valve is permitted; and
when pressure supplied from the reel-out port to the pilot pressure inlet is below the counterbalance valve threshold, hydraulic fluid flow from the reel-in port through the counterbalance valve to the pilot-operated directional valve is obstructed.
